(19) United States
(12) Patent Application Publication
(10) Pub. No.: US 2006/0291436 A1
(43) Pub. Date: Dec. 28, 2006

(54) Block acknowledgement in aggregated frame sequences

(75) Inventor: Solomon Trainin, Haifa (IL)

Correspondence Address: LeMOINE PATENT SERVICES, PLLC, C/O INTELLEVATE, P. O. BOX 52050, MINNEAPOLIS, MN, 55402, US

(73) Assignee: Intel Corporation

(21) Appl. No.: 11/159,771

(22) Filed: Jun. 23, 2005

(51) Int. Cl. H04Q 7/24

(52) U.S. Cl. 370/338; 370/392

(57) ABSTRACT

An initiator in a wireless network may transmit aggregated frames with or without block acknowledgement requests. The initiator and a responder may share responsibility for acknowledgement sequences or the responder may have full responsibility for acknowledgement sequences.

### FIELD

The present invention relates generally to computer networks, and more specifically to wireless networks.

### BACKGROUND

Access points and mobile stations that communicate in wireless networks may communicate by sending and receiving medium access control (MAC) protocol data units (MPDUs). Aggregation is a way to concatenate many MPDUs into single physical layer (PHY) protocol data units (PPDUs). An “initiator” mobile station or access point may send an aggregated PPDU that includes data and a request to acknowledge receipt of the data. The acknowledgement request may be made by sending an MPDU with a block acknowledgement request (BAR). A “responder” mobile station or access point may respond to the BAR by sending an MPDU with a block acknowledgement (BA) to acknowledge receipt of the data in the aggregated PPDU.

### BRIEF DESCRIPTION OF THE DRAWINGS

FIG. 1 shows a diagram of a wireless network;

FIGS. 2 and 3 show initiator and responder exchanges that include aggregated and non-aggregated physical layer protocol data units (PPDUs);

FIG. 4 shows a block acknowledgement request recovery process;

FIGS. 5 and 6 show flowcharts in accordance with invention embodiments in which an initiator and responder have joint block acknowledgement (BA) responsibility;

FIGS. 7 and 8 show flowcharts in accordance with invention embodiments in which a responder has full BA responsibility; and

FIG. 9 shows a system diagram in accordance with various embodiments of the present invention.

### DESCRIPTION OF EMBODIMENTS

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

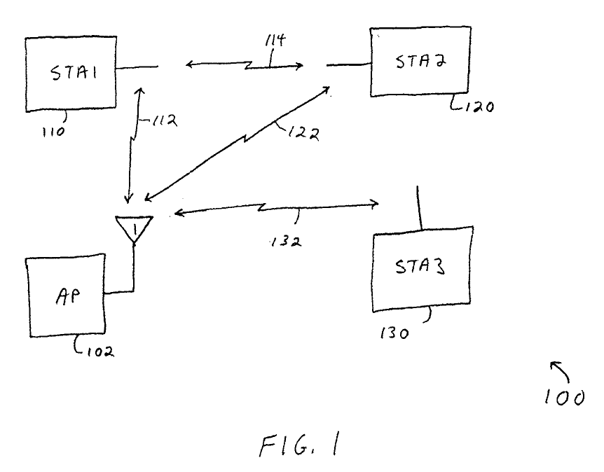

FIG. 1 shows a diagram of a wireless network. Wireless network 100 includes access point (AP) 102 and mobile stations (STA) 110, 120, and 130. In some embodiments, wireless network 100 is a wireless local area network (WLAN). For example, one or more of mobile stations 110, 120, and 130, or access point 102 may operate in compliance with a wireless network standard such as IEEE Std. 802.11, 1999 Edition, although this is not a limitation of the present invention. As used herein, the term “802.11” refers to any past, present, or future IEEE 802.11 standard, or extension thereto, including, but not limited to, the 1999 edition. Mobile stations 110, 120, and 130 may be any type of mobile station capable of communicating in network 100. For example, the mobile stations may be computers, personal digital assistants, wireless-capable cellular phones, home audio or video appliances, or the like.

Access point 102 communicates with mobile station 110 (also referred to as “STA1”) using signal 112. Access point 102 communicates with mobile station 120 (also referred to as “STA2”) using signal 122, and access point 102 communicates with mobile station 130 (also referred to as “STA3”) using signal 132. In some embodiments, mobile stations communicate directly. For example, as shown in FIG. 1, mobile station 110 may communicate with mobile station 120 using signal 114. In some embodiments, signals 112, 122, and 132 are transmitted through a shared medium. For example, in some embodiments, the shared medium is the wireless channel in free space between the access point and the various mobile stations. Although AP 102 and mobile stations 110, 120, and 130 are shown communicating using a wireless shared medium in FIG. 1, this is not a limitation of the present invention. For example, in some embodiments, the shared medium may include one or more wires, and in other embodiments, the shared medium includes optical media. Further, in some embodiments, mobile stations may communicate with other mobile stations using the wireless shared medium.

In some embodiments, the various access points and mobile stations contend for the shared medium using a collision sense multiple access with collision avoidance (CSMA/CA) random access scheme. For example, a distributed coordination function (DCF) or enhanced distributed coordination function (EDCF) may be implemented in AP 102, and may also be implemented in mobile stations 110, 120, and 130 to provide a mechanism for the various elements shown in FIG. 1 to contend for the shared medium. In some embodiments, a DCF or EDCF may be implemented that is in compliance with an IEEE 802.11 standard, and in other embodiments, a DCF or EDCF may be implemented that is partially compliant with an IEEE 802.11 standard.

In some embodiments, the various access points and mobile stations use a contention-free access scheme to access the shared medium. For example, a point coordination function (PCF) or hybrid coordination function (HCF) may be implemented in AP 102 to provide for contention-free communications with one or more of mobile stations 110, 120, and 130. In some embodiments, a PCF or HCF may be implemented that is in compliance with an IEEE 802.11 standard, and in other embodiments, a PCF or HCF may be implemented that is partially compliant with an IEEE 802.11 standard.

For the purposes of this description, the term “initiator” refers to any mobile station or access point that initiates an access of the shared medium to communicate with one or more other mobile stations or access points. For example, any of access point 102 or mobile stations 110, 120, or 130 may be an initiator in this context. Further, the term “responder” refers to any mobile station or access point that responds to an initiator. For example, any of access point 102 or mobile stations 110, 120, or 130 may be a responder in this context.

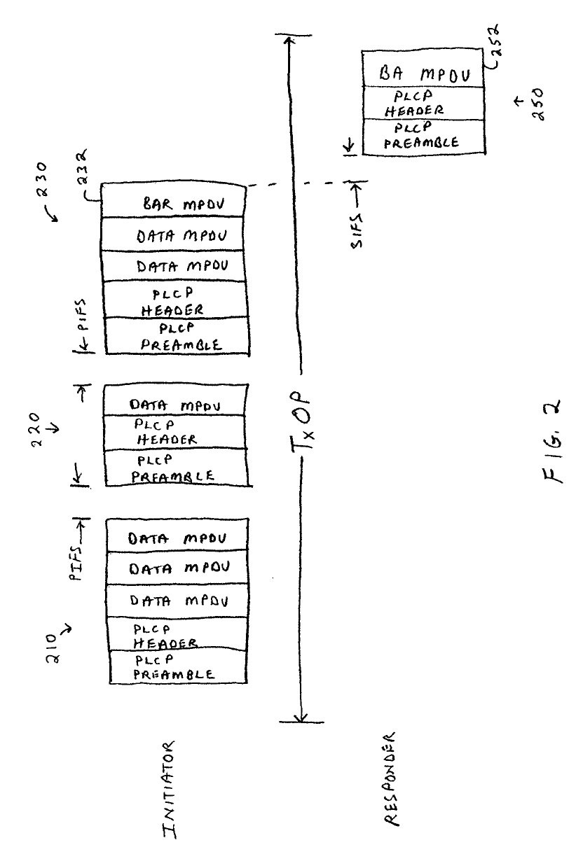

FIG. 2 shows an initiator and responder exchange that includes aggregated and non-aggregated physical layer protocol data units (PPDUs). The transmit opportunity (TxOP) shown in FIG. 2 begins with a channel access by the initiator. In some embodiments, the initiator may be an access point that uses contention-free access to access the channel. In other embodiments, the initiator may be an access point that contends for the channel using a CSMA/CA mechanism. In still further embodiments, the initiator may be a mobile station that initiates the channel access. The channel access may be distributed (e.g., IEEE 802.11 DCF transmit opportunity “TxOP”) or centralized (e.g., IEEE 802.11 polled TxOP). The manner in which the channel is accessed is not a limitation of the present invention.

The top portion of FIG. 2 shows transmissions made by an initiator during a TxOP, and the bottom portion of FIG. 2 shows transmissions made by a responder in the same TxOP. The initiator is shown transmitting three PPDUs 210, 220, and 230. PPDUs 210 and 230 are aggregated PPDUs. Aggregation is a way to concatenate many MPDUs into single PPDUs. The aggregation allows higher data throughput by lowering the PHY overhead and MAC overhead normally associated with transmitting a MPDU. For example, PHY overhead includes physical layer convergence procedure (PLCP) preambles and PLCP headers, and MAC overhead includes time consumed by short interframe spaces (SIFs). The format of an aggregated frame at the PHY level appears similar to non-aggregated frames, and includes a PLCP preamble, a PLCP header, and a payload that includes a number of MPDUs.

MPDUs may include many different types of payload. MPDUs that have data meant for the responder are referred to herein as “data MPDUs.” MPDUs that include block acknowledgement requests (BARs) are referred to herein as “BAR MPDUs,” and MPDUs that include block acknowledgements are referred to herein as “BA MPDUs.”

As shown in FIG. 2, PPDU 210 is an aggregated PPDU that includes a PLCP preamble, a PLCP header, and three data MPDUs. PPDU 220 is a non-aggregated PPDU that includes a PLCP preamble, a PLCP header, and one data MPDU. PPDU 230 is an aggregated PPDU that includes a PLCP preamble, a PLCP header, two data MPDUs, and a Block ACK Request (BAR) MPDU 232.

As shown in FIG. 2, not every PPDU includes a BAR. For example, aggregated PPDU 210 and non-aggregated PPDU 220 do not include a BAR. Also for example, aggregated PPDU 230 includes BAR MPDU 232. In some embodiments, an initiator will determine when to send a BAR based on one or more criteria. For example, an initiator may keep track of how much data has been transmitted since the last BAR has been sent or since the last Block ACK (BA) has been received, and a BAR may be sent when the amount of data exceeds a threshold. In some embodiments, the threshold may be determined by a buffer threshold in a responder.

By not transmitting a BAR MPDU in each aggregated PPDU, the initiator may save bandwidth, in part because fewer BAR MPDUs are transmitted, and potentially fewer BA MPDUs are transmitted by the responder.

The PPDUs shown transmitted by the initiator are separated by short interframe space (SIFS). In some embodiments, a BA PPDU may be received during one or more short interframe space (SIFS) between the initiator transmitted PPDUs.

In response to receiving BAR MPDU 232, the responder transmits PPDU 250 which includes a PLCP preamble, a PLCP header, and BA MPDU 252. When the initiator receives the BA MPDU 252, the data transmitted by the initiator has been acknowledged by the responder, and the initiator may refrain from sending another BAR MPDU until the threshold has again been exceeded.

In some embodiments, the responder may also keep track of how much data has been received and may send a BA MPDU without first receiving a BAR MPDU from the initiator. For example, the responder may have a buffer to receive data from the initiator, and when the amount of data in the buffer exceeds a threshold, the responder may send a BA MPDU without first receiving a BAR MPDU from the initiator.

FIG. 2 shows a single BAR MPDU being transmitted by the initiator, and that BAR is at the end of the last transmitted PPDU, although this is not a limitation of the present invention. For example, in some embodiments, an initiator may put a BAR in any place in any PPDU. An initiator may statistically find that a BAR is more reliable when placed in one or more “spots” in a PPDU, and may then place BARs in those spots. Further, in some embodiments, a single PPDU may include multiple BAR MPDUs directed to the same responder.

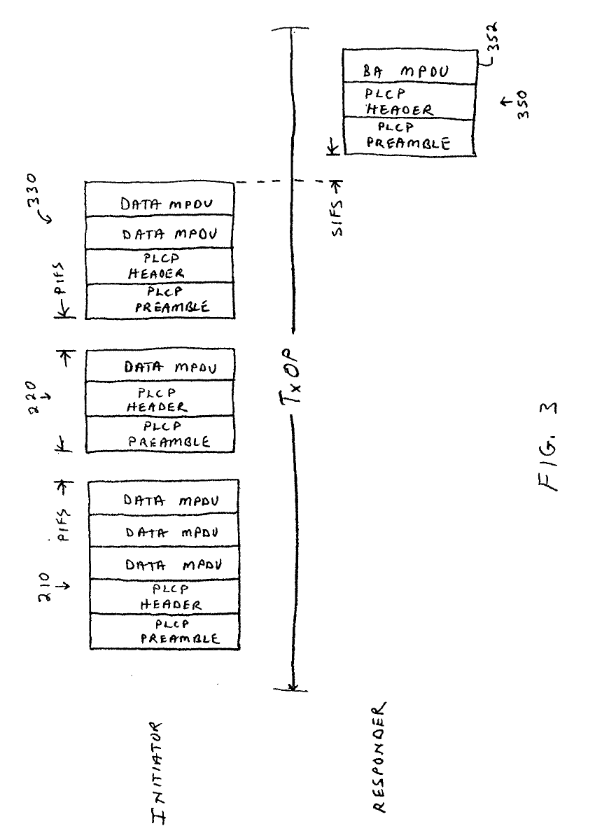

The exchange shown in FIG. 2 provides a mechanism to acknowledge receipt of data MPDUs in sequences of aggregated frames without sending a BAR and BA for every PPDU. Various embodiments of the present invention split the responsibility for the ACK sequences between the initiator and responder in different ways. For example, in embodiments represented by FIG. 2, responsibility for the BA sequences is shared between the initiator and responder. The responder may volunteer a BA after a certain amount of data has been received, and the initiator may also request a BA by transmitting a BAR after a certain amount of data has been sent. In embodiments represented by FIG. 3, described next, the responder has full responsibility for the BA sequences.

FIG. 3 shows an initiator and responder exchange that includes aggregated and non-aggregated physical layer protocol data units (PPDUs). As shown in FIG. 3, the initiator transmits aggregated PPDU 210 and non-aggregated PPDU 220, which are described above with reference to FIG. 2. The initiator also transmits aggregated PPDU 330. In contrast to embodiments represented by FIG. 2, the initiator in embodiments represented by FIG. 3 does not transmit a BAR MPDU. In embodiments represented by FIG. 3, the responder has full responsibility for the BA sequences. For example, the responder of FIG. 3 transmits PPDU 350 that includes BA MPDU 352 without first receiving a BAR from the initiator.

In some embodiments, the responder keeps track of the amount of data received from the initiator, and when the amount of data received crosses a threshold, the responder sends a BA MPDU without first receiving a BAR MPDU from the initiator. Also for example, if a buffer threshold within the responder is reached or passed, the responder may send a BA MPDU. As shown in FIG. 3, PPDUs sent by the initiator may have a duration of a priority interframe space (PIFS), thus preventing contention with BA PPDUs sent by the responder.

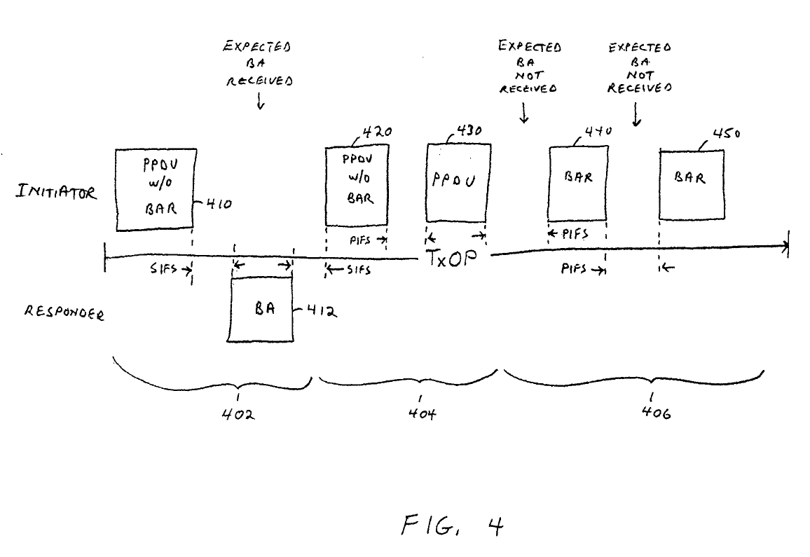

Even though the acknowledgement responsibility lies with the responder in embodiments represented by FIG. 3, the initiator may still keep track of how much data has been sent, and may also keep track of when to expect a BA from the responder. If an expected BA is not received, the initiator may start a BAR recovery process. A BAR recovery process is shown in FIG. 4.

FIG. 4 shows a block acknowledgement request (BAR) recovery process. The TxOP of FIG. 4 is divided into three time segments to aid in the description. Segment 402 shows PPDU 410 transmitted by the initiator followed by BA 412 being transmitted by the responder. Note that PPDU 410 does not contain a BAR. The exchange at segment 402 may occur when a responder volunteers a BA in a shared BA responsibility system, or may occur when a responder timely transmits a BA in a system in which the responder has full BA responsibility.

Segment 404 shows the initiator transmitting PPDUs 420 and 430. PPDUs may be aggregated or non-aggregated. Note that PPDU 420 is transmitted without a BAR, and that PPDU 430 may be transmitted with or without a BAR. In either case, the initiator is expecting a BA after the transmission of PPDU 430. For example, in shared BA responsibility embodiments, PPDU 430 may include a BAR to request acknowledgement of MPDUs included in PPDUs 420 and 430. Also for example, in full responder BA responsibility embodiments, PPDU 430 may not include a BAR, and the initiator expects a BA based on the responder recognizing that a threshold has been reached.

In the example of FIG. 4, the initiator expects a BA after the transmission of PPDU 430 and does not receive a BA. At this point, the BAR recovery starts. The BAR recovery is shown generally at time segment 406. The initiator transmits BAR 440 and expects a BA. The BA is not received, so the initiator transmits another BAR at 450. This process may continue until an appropriate BA is received, or the link is otherwise disposed of.

In various embodiments of the present invention, the BAR recovery process is used as an exception process to reduce the number of small PPDUs transmitted by the initiator. For example, when a single BAR MPDU is included in a PPDU, such as those shown at 440 and 450, PHY overhead and MAC overhead is incurred for each BAR. When incurred, this overhead reduces the bandwidth savings that are otherwise generated in sequences of aggregated frames.

The BAR recovery process show in FIG. 4 may be utilized in any of the embodiments of the present invention. For example, the BAR recovery process may be performed in embodiments represented by FIG. 2, and may also be performed in embodiments represented by FIG. 3.

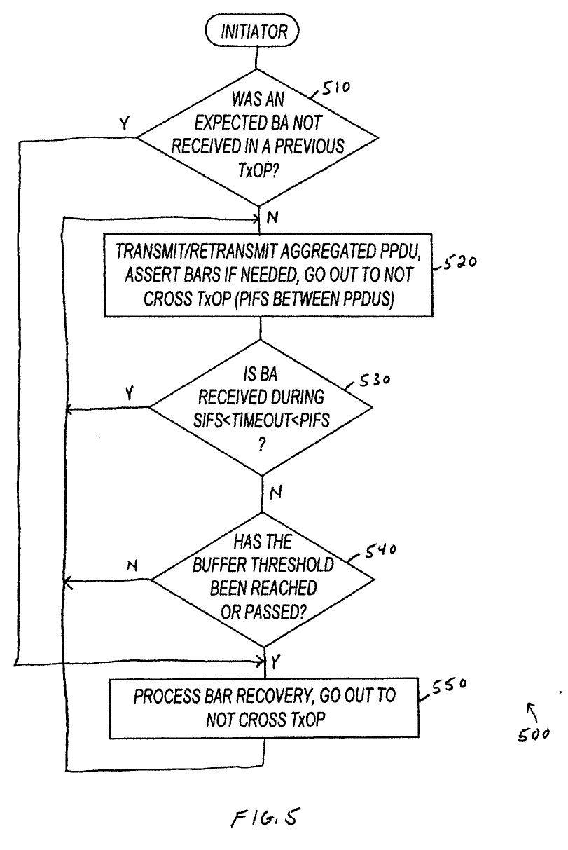

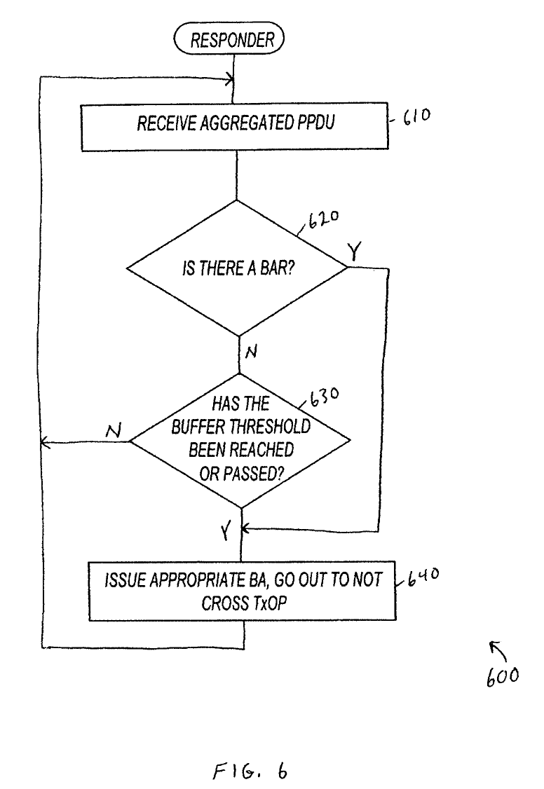

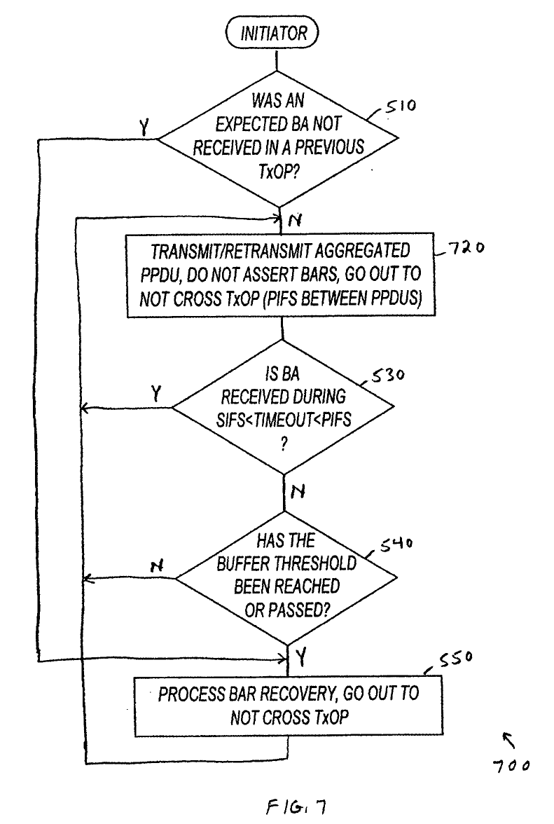

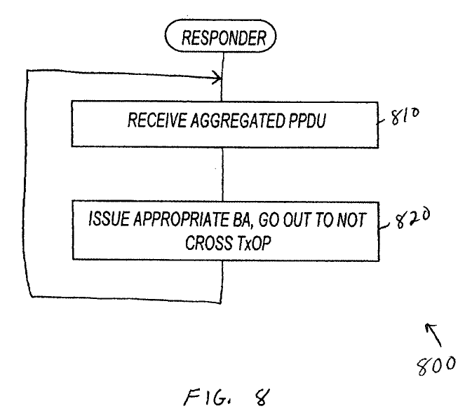

FIGS. 5-8 show flowcharts in accordance with various embodiments of the present invention. FIGS. 5 and 6 show flowcharts of embodiments in which BA responsibility is shared between an initiator and a responder, and FIGS. 7 and 8 show flowcharts of embodiments in which the responder has full BA responsibility. The BAR recovery process shown in FIG. 4 may be utilized in any of the disclosed embodiments regardless of the distribution of BA responsibility.

FIG. 5 shows a flowchart in accordance with various embodiments of the present invention. In some embodiments, method 500 may be used by an initiator that shares BA responsibility with a responder in a wireless network. In some embodiments, method 500, or portions thereof, is performed by an access point, a mobile station, a processor, or an electronic system, embodiments of which are shown in the various figures. Method 500 is not limited by the particular type of apparatus, software element, or system performing the method. The various actions in method 500 may be performed in the order presented, or may be performed in a different order. Further, in some embodiments, some actions listed in FIG. 5 are omitted from method 500.

Method 500 is shown beginning at block 510 in which the initiator determines whether an expected BA was not received in a previous TxOP. If an expected BA has not been received, method 500 proceeds to block 550 in which a BAR recovery process is performed. Further, in block 550, if there is not sufficient time left in the TxOP, method 500 will suspend so as to not cross the TxOP boundary.

If at 510 the initiator determines that a BA is not currently expected, method 500 continues at block 520. At block 520, aggregated PPDUs are transmitted and BARs are asserted as needed. In some embodiments, this corresponds to the exchange shown in FIG. 2, where non-aggregated PPDU 220 and aggregated PPDUs 210 and 230 are transmitted. Further, method 500 may be suspended at block 520 if there is not sufficient time left in the current TxOP.

At 530, method 500 determines if a BA is received between a short interframe space (SIFS) and a priority interframe space (PIFS). If a BA is received, method 500 continues again at block 520 where more aggregated and non-aggregated PPDUs may be transmitted. If a BA is not received at 530, method 500 proceeds at block 540 where a determination is made whether a buffer threshold has been reached or passed. If the buffer threshold has not been reached or passed, method 500 continues at block 520 where more aggregated and non-aggregated PPDUs may be transmitted. If the buffer threshold has been reached or passed, then a BAR recovery process is begun at block 550.

FIG. 6 shows a flowchart in accordance with various embodiments of the present invention. In some embodiments, method 600 may be used by a responder that shares BA responsibility with an initiator. In some embodiments, method 600, or portions thereof, is performed by a mobile station, a processor, or an electronic system, embodiments of which are shown in the various figures. Method 600 is not limited by the particular type of apparatus, software element, or system performing the method. The various actions in method 600 may be performed in the order presented, or may be performed in a different order. Further, in some embodiments, some actions listed in FIG. 6 are omitted from method 600.

Method 600 is shown beginning at block 610 in which the responder receives one or more aggregated PPDUs. At 620, the responder determines if one or more of the received PPDUs includes a BAR. If one of the PPDUs includes a BAR, method 600 proceeds with block 640 to issue an appropriate BA. Further, if there is not sufficient time in the current TxOP, method 600 suspends at block 640. If, at 620, it is determined there is no BAR in any of the received aggregated PPDUs, then at 630, method 600 determines whether a buffer threshold has been reached or passed. If the buffer threshold has not been reached or passed, method 600 continues at 610 to receive further PPDUs. If the buffer threshold has been reached or passed, method 600 continues with block 640 in which an appropriate BA is issued.

FIG. 7 shows a flowchart in accordance with various embodiments of the present invention. In some embodiments, method 700 may be used by an initiator when a responder has full BA responsibility. In some embodiments, method 700, or portions thereof, is performed by a mobile station, a processor, or an electronic system, embodiments of which are shown in the various figures. Method 700 is not limited by the particular type of apparatus, software element, or system performing the method. The various actions in method 700 may be performed in the order presented, or may be performed in a different order. Further, in some embodiments, some actions listed in FIG. 7 are omitted from method 700.

Method 700 includes blocks 510, 530, 540, and 550, all of which are described above with reference to FIG. 5. Method 700 also includes block 720 in which aggregated PPDUs are transmitted without BARs. The difference between method 700 and method 500 is that an initiator in method 700 will not transmit any BARs unless a BAR recovery process is started. Because the BA responsibility lies fully with the responder, the initiator expects to receive BAs periodically without first transmitting BARs.

FIG. 8 shows a flowchart in accordance with various embodiments of the present invention. In some embodiments, method 800 may be used by a responder that has full BA responsibility. In some embodiments, method 800, or portions thereof, is performed by a mobile station, a processor, or an electronic system, embodiments of which are shown in the various figures. Method 800 is not limited by the particular type of apparatus, software element, or system performing the method. The various actions in method 800 may be performed in the order presented, or may be performed in a different order. Further, in some embodiments, some actions listed in FIG. 8 are omitted from method 800.

Method 800 is shown beginning at block 810 in which the responder receives one or more aggregated PPDUs. At 820, an appropriate BA is issued in response to the amount of data received in the aggregated PPDU. For example, a BA may not be issued until a certain amount of data has been received or until a buffer threshold has been reached or passed. Further, if there is not sufficient time left in the current transmit opportunity, method 800 will suspend at block 820.

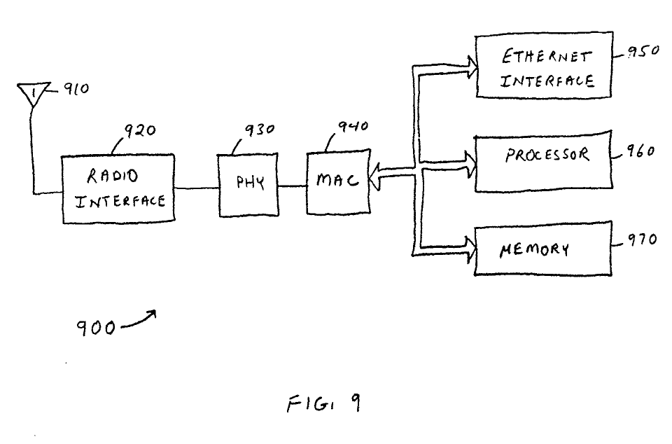

FIG. 9 shows a system diagram in accordance with various embodiments of the present invention. Electronic system 900 includes antenna 910, radio interface 920, physical layer (PHY) 930, medium access control (MAC) mechanism 940, Ethernet interface 950, processor 960, and memory 970. In some embodiments, electronic system 900 may be an access point or mobile station capable of communicating using sequences of aggregated frames. In some embodiments, electronic system 900 may be an access point or mobile station that can aggregate multiple MPDUs in PPDUs with or without acknowledgement requests. For example, electronic system 900 may be utilized in network 100 as access point 102, or as one of mobile stations 110, 120, or 130. Also for example, electronic system 900 may be an access point or mobile station capable of communicating using any of the methods described with reference to the previous figures.

In some embodiments, electronic system 900 may represent a system that includes an access point or mobile station as well as other circuits. For example, in some embodiments, electronic system 900 may be a computer, such as a personal computer, a workstation, or the like, that includes a network interface as a peripheral or as an integrated unit. Further, electronic system 900 may include a series of access points that are coupled together in a network.

Antenna 910 may be a directional antenna or an omni-directional antenna. As used herein, the term omni-directional antenna refers to any antenna having a substantially uniform pattern in at least one plane. For example, in some embodiments, antenna 910 may be an omni-directional antenna such as a dipole antenna, or a quarter wave antenna. Also for example, in some embodiments, antenna 910 may be a directional antenna such as a parabolic dish antenna or a Yagi antenna. In still further embodiments, antenna 910 includes multiple physical antennas. For example, in some embodiments, multiple antennas are utilized to multiple-input-multiple-output (MIMO) processing or spatial-division multiple access (SDMA) processing.

In operation, system 900 sends and receives signals using antenna 910, and the signals are processed by the various elements shown in FIG. 9. Radio interface 920 is coupled to antenna 910 to interact with a wireless network. Radio interface 920 may include circuitry to support the transmission and reception of radio frequency (RF) signals. For example, in some embodiments, radio interface 920 includes an RF receiver to receive signals and perform “front end” processing such as low noise amplification (LNA), filtering, frequency conversion or the like. Also for example, in some embodiments, radio interface 920 may include circuits to support frequency up-conversion, and an RF transmitter. The invention is not limited by the contents or function of radio interface 920.

Physical layer (PHY) 930 may be any suitable physical layer implementation. For example, PHY 930 may be a circuit block that implements a physical layer that complies with an IEEE 802.11 standard or other standard. Examples include, but are not limited to, direct sequence spread spectrum (DSSS), frequency hopping spread spectrum (FHSS), and orthogonal frequency division multiplexing (OFDM).

Medium access control (MAC) mechanism 940 may be any suitable medium access control layer implementation. For example, MAC 940 may be implemented in software, or hardware or any combination thereof In some embodiments, a portion of MAC 940 may be implemented in hardware, and a portion may be implemented in software that is executed by processor 960. Further, MAC 940 may include a processor separate from processor 960. MAC 940 may implement any of the communications embodiments of the present invention. For example, MAC 940 may provide aggregated or non-aggregated PPDUs for transmission on a shared medium.

Processor 960 may perform method embodiments of the present invention, such as method 500 (FIG. 5), method 600 (FIG. 6), method 700 (FIG. 7), or method 800 (FIG. 8). Processor 960 represents any type of processor, including but not limited to, a microprocessor, a digital signal processor, a microcontroller, or the like.

Memory 970 represents an article that includes a machine readable medium. For example, memory 970 represents a random access memory (RAM), dynamic random access memory (DRAM), static random access memory (SRAM), read only memory (ROM), flash memory, or any other type of article that includes a medium readable by processor 960. Memory 970 may store instructions for performing the execution of the various method embodiments of the present invention.

Ethernet interface 950 may provide communications between electronic system 900 and other systems. For example, in some embodiments, electronic system 900 may be an access point that utilizes Ethernet interface 950 to communicate with a wired network or to communicate with other access points. Some embodiments of the present invention do not include Ethernet interface 950. For example, in some embodiments, electronic system 900 may be a network interface card (NIC) that communicates with a computer or network using a bus or other type of port.

Although the present invention has been described in conjunction with certain embodiments, it is to be understood that modifications and variations may be resorted to without departing from the spirit and scope of the invention as those skilled in the art readily understand. Such modifications and variations are considered to be within the scope of the invention and the appended claims.

What is claimed is:

1. A method comprising:
receiving a plurality of medium access control (MAC) protocol data units (MPDUs); and
transmitting a block acknowledgement (BA) regardless whether a block acknowledgement request (BAR) is received.

2. The method of claim 1 wherein transmitting a BA comprises:
determining if a buffer threshold has been reached; and
if the buffer threshold has been reached, transmitting the BA.

3. The method of claim 1 further comprising transmitting a BA if a block acknowledgement request (BAR) is received.

4. The method of claim 1 wherein receiving a plurality of MPDUs comprises receiving at least one physical layer (PHY) protocol data unit (PPDU) that includes more than one data MPDU.

5. The method of claim 1 wherein receiving a plurality of MPDUs comprises receiving at least one physical layer (PHY) protocol data unit (PPDU) that includes at least one MPDU with a BAR.

6. The method of claim 1 wherein receiving a plurality of MPDUs comprises receiving at least one physical layer (PHY) protocol data unit (PPDU) that only includes MPDUs without a BAR.

7. A method comprising:
transmitting an aggregated physical layer (PHY) protocol data unit (PPDU);
determining whether a buffer threshold has been reached; and
if the buffer threshold has been reached without receiving a block acknowledgement (BA), transmitting a block acknowledgement request (BAR).

8. The method of claim 7 wherein transmitting an aggregated PPDU comprises transmitting a plurality of medium access control (MAC) protocol data units (MPDU), wherein at least one of the plurality of MPDUs includes a BAR.

9. The method of claim 7 wherein transmitting an aggregated PPDU comprises transmitting a plurality of medium access control (MAC) protocol data units (MPDU) without including a BAR.

10. The method of claim 7 wherein the method is performed by a medium access control (MAC) layer operating in compliance with an IEEE 802.11 standard.

11. The method of claim 7 further comprising repeating the BAR transmission if a BA is not received in response thereto.

12. The method of claim 7 further comprising transmitting at least one non-aggregated PPDU with the one aggregated PPDU.

13. An apparatus including a medium adapted to hold machine-accessible instructions that when accessed result in a machine performing:
receiving a plurality of medium access control (MAC) protocol data units (MPDUs); and
transmitting a block acknowledgement (BA) regardless whether a block acknowledgement request (BAR) is received.

14. The apparatus of claim 13 wherein transmitting a BA comprises:
determining if a buffer threshold has been reached; and
if the buffer threshold has been reached, transmitting the BA.

15. The apparatus of claim 13 wherein the machine-accessible instructions when accessed result in the machine further performing transmitting a BA if a block acknowledgement request (BAR) is received.

16. The apparatus of claim 13 wherein receiving a plurality of MPDUs comprises receiving at least one physical layer (PHY) protocol data unit (PPDU) that includes more than one MPDU.

17. An electronic system comprising:
an antenna;
a radio interface coupled to the antenna;
a medium access control (MAC) mechanism coupled to the radio interface to transmit MAC protocol data units (MPDU) and to transmit a block acknowledgement request (BAR) only when a block acknowledgment (BA) has not first been received; and
an Ethernet interface coupled to the medium access control mechanism.

18. The electronic system of claim 17 wherein the medium access control mechanism operates in compliance with an IEEE 802.11 standard.

19. The electronic system of claim 17 wherein the medium access control mechanism is adapted to keep track of how much data is being transmitted since last receiving a BA, and to transmit a BAR when a threshold is reached without first receiving a BA.

20. The electronic system of claim 19 wherein the medium access control mechanism is further adapted to repeat a BAR transmission if a BA is not received in response thereto.
